(19) United States
(12) Patent Application Publication
(10) Pub. No.: US 2013/0326501 A1
(43) Pub. Date: Dec. 5, 2013

(54) CLOUD SYSTEM HAVING FLEXIBLE APPLICATIONS

(71) Applicant: Sung-Jen HSIANG, Taichung (TW)

(72) Inventor: Sung-Jen HSIANG, Taichung (TW)

(21) Appl. No.: 13/482,227

(22) Filed: May 29, 2012

(51) Int. Cl. G06F 9/445; G06F 15/16

(52) U.S. Cl. 717/178

(57) ABSTRACT

A cloud system having flexible applications mainly includes an executing module of client computers, a packager for software virtualization, and a server for software virtualization. The packager and the server are constructed on a Cloud platform. The packager stores applied software and archive files created after virtualization; the server connects with the packager for providing the archive files of the applied software to client computers. Installed in the client computers, the executing module of client computers further virtually creates a Cloud Relation Area for receiving and storing the archive files from the downloaded applied software. The client computers utilize the applied software on the Cloud platform via the executing module of client computers under an on-line pattern or an off-line pattern.

### BACKGROUND OF THE INVENTION

1. Field of the Invention

The present invention relates to a Platform as a Server for virtualizing Cloud software on a Cloud platform thereof; client computers are able to flexibly execute the Cloud software via an on-line connection or an off-line connection on the Cloud platform.

2. Description of the Related Art

Cloud computing, as defined by the US National Institutes of Standards & Technology is directed to services according to three fundamental models:

1. Software as a Service, SaaS): Client computers access applied programs in the Cloud via Internet.

2. Platform as a Service, Paas): The developed applied programs are delivered to the Cloud.

3. Infrastructure as a Service, IaaS): This model is directed to rental services of processors, storage, networks, and other sources. The client computers do not have to manage the infrastructure of the Cloud, but operating systems, storage, networks, allocated applied programs are all controlled, and Internet elements are also freely adopted.

As to the Platform as a Service (PaaS), there are some influential manufacturers offering correlated technology. Although this product is gradually maturing, since a large amount of manpower and a large investment have been devoted to it, there are still some shortcomings, which are listed as follows:

1. The software only allows a few users to access a single server. In order to allow access to as many users as possible, the server has to be expanded, and other related hardware has to be upgraded as well. Therefore, the cost increases.

2. The Cloud software is accessed via terminal transmission. Herein, the terminal transmission has to be kept in an on-line state. An off-line transmission is not allowable.

3. The transmission of a large amount of data adversely augments the load of the network, which causes slow transmission and abrupt disconnections.

4. A terminal frame cannot provide an ideal FPS (Frame/Per Second). Therefore, a lot of software can not be practically applied in the platform.

5. The server is always in a high loading state. Therefore, many extra costs are incurred.

6. The resources at the client computers are somehow wasted. Namely, today's computers are usually provided with hardware or facilities of a certain level. Therefore, it is inefficient for these computers to serve as Thin Clients.

### SUMMARY OF THE INVENTION

The object of the present invention is to provide a Cloud system having flexible applications. The Cloud platform virtualizes Cloud software for client computers to flexibly access the Cloud software via an on-line connection or an off-line connection thereon.

The Cloud system having flexible application can be adopted in a virtual environment at client computers (abbreviated as Local virtualization) and a virtual environment at a Cloud server (abbreviated as Server virtualization). If the client computer utilizes a high power PC, Local virtualization is adopted for accessing applied software on the Cloud platform. If the client computer utilizes a Thin Client, Server virtualization is adopted for accessing applied software on the Cloud platform. Namely, it is available for client computers to freely choose the Local virtualization, the Server virtualization, or the both virtualizations.

A further object of the present invention is to provide a Cloud system having flexible applications so as to decrease costs for constructing Cloud servers, lower loads on the Cloud server, reduce transmitting flows of the network, centralize management and using behavior on the software, simplify publication of software, maximize a using rate of resources, promote using convenience (since an executing module of client computers is installed on the computer of the client computers, exploring websites allows the Cloud software to be freely accessed via the on-line connection or the off-line connection), trace using habits of software/hardware of client computers, and provide services of software on demand.

The Cloud system in accordance with the present invention comprises:

a packager for software virtualization and a server for software virtualization being installed on a Cloud platform; the packager for software virtualization saving applied software and archive files generated after virtualization; the server for software virtualization being connected with the packager for software virtualization so as to provide the archive files of the applied software to client computers; and

an executing module of client computers; a Cloud Relation Area being virtually installed in the client computers; the executing module of client computers letting the client computers connect with the Cloud platform; the Cloud Relation Area receiving and storing the archive files of the applied software that is downloaded; the client computers utilizing the applied software on the Cloud platform via the executing module of client computers under an on-line pattern or an off-line pattern.

### BRIEF DESCRIPTION OF THE DRAWINGS

FIG. 1 is a main frame of the present invention;

FIG. 2 is a flowchart that packages software of the present invention;

FIG. 3 is a flowchart of tracking and managing of the present invention; and

FIG. 4 is a flowchart showing a virtual environment of a Cloud server of the present invention.

### DETAILED DESCRIPTION OF THE PREFERRED EMBODIMENTS

### Cloud System

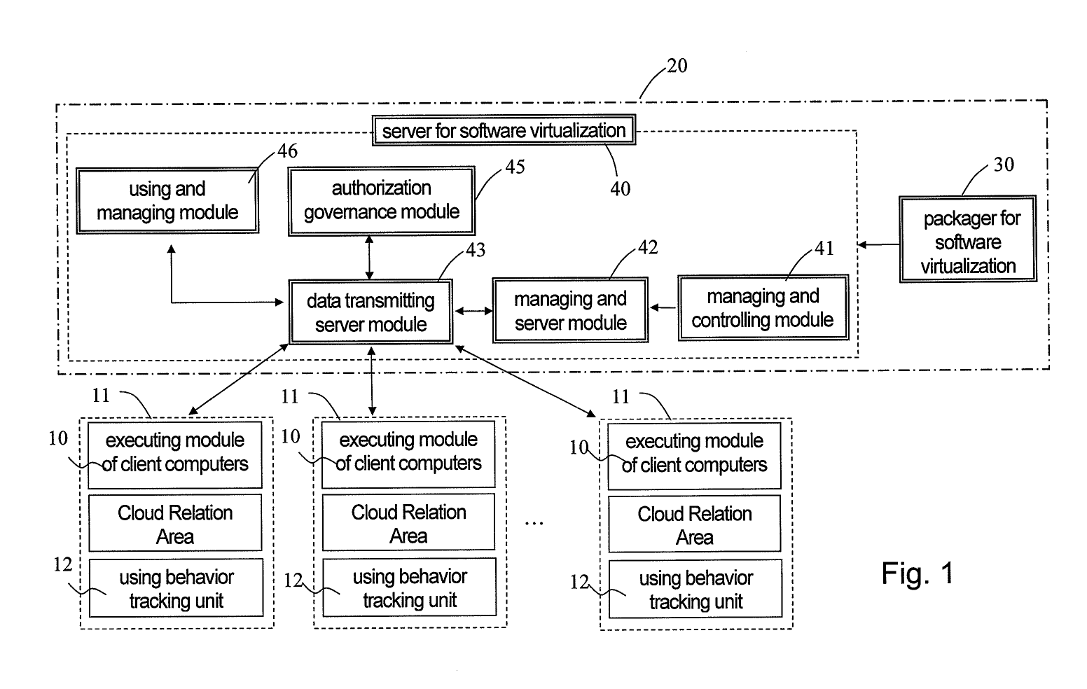

FIG. 1 shows a Cloud system having flexible applications comprises:

an executing module 10 of client computers; a Cloud Relation Area being virtually installed in client computers 11; the executing module 10 of client computers letting the client computers 11 connect with a Cloud platform 20 so as to download or start applied software on the Cloud platform 20; the Cloud Relation Area receiving and storing previously discussed downloaded applied software; the client computers 11 utilizing the applied software on the Cloud platform 20 via the executing module 10 of client computers under an on-line pattern or an off-line pattern; and a packager 30 for software virtualization and a server 40 for software virtualization being installed on the Cloud platform 20; the packager 30 for software virtualization saving applied software and archive files generated after virtualization of the applied software; the server 40 for software virtualization being connected with the packager 30 for software virtualization so as to provide the applied software to the executing module 10 of client computers.

[Packager 30 for Software Virtualization]

The packager 30 for software virtualization stores various applied software and the archive files of the applied software after virtualization of the applied software. The server 40 for software virtualization dispatches the archive files of the applied software to the client computers 11. After virtualization, the software can be freely applied in different operating systems of the client computers 11.

Since the operating systems adopted in the client computers 11 are different, the environment for virtualizing the software has to be considered. Namely, different operating systems, such as Windows 2000, Windows Xp, and Windows 7, require different settings. The virtualization of the software packs the software into a file of a certain form and classifies all the files of the software into “files for firstly starting software” and “files for running the software”. The classification of the files is executed for the client computers to conveniently access the applied software. When the “files for firstly starting software” are accessed from the Cloud and stored in the Cloud Relation Area of the client computers 11, the files can be run in advance. Accordingly, the “files for running the software” are gradually downloaded to the Cloud Relation Area of the client computers 11.

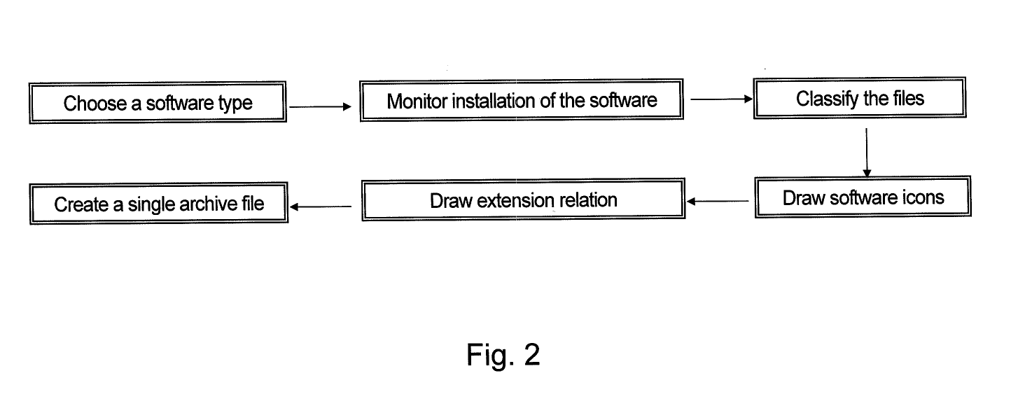

Packing the software can be divided into six procedures as shown in FIG. 2 as follows:

Procedure 1: Select a type of software. The software can be divided into Need Installed software, Green software, Web-based software, and Virtualization environment software. Types of software are listed as follows:

| | |
|---|---|
| Need Installed | Normally, when the software is to be installed, such |
| software | as the MSI file or EXE file of the SETUP, a compact |
| | installing program will be provided. Usually, this |
| | type of software firstly registers some software |
| | information to the operating system and installs |
| | some subordinate contents such as the Start List. |
| | This type of software collects all transaction files |
| | during the virtualization and installation. |
| | Different from other software, the Need Installed |
| | software further has registry file virtualization |
| | and service virtualization. The related registry |
| | files and service files are compactly analyzed and |
| | turned in as a single archive file. |
| Green software | Virtualization is simply executed to the Green |
| | software. If the software requires some settings, |
| | the settings can be integrally packed during the |
| | virtualization. Therefore, users do not have to do |
| | the settings while using the software. |
| Web-based | Hyperlinks on the Website are all recorded and |
| software | information related to the software is inserted for |
| | creating a single archive file. |
| Virtualization | A route to the installed software in the virtual |
| environment | environment should be inserted, so that when client |
| software | computers are connected with the virtual |
| | environment, a host is notified to run the software. |

Procedure 2: Monitor the installation of the software. During the software virtualization, the software has to be firstly installed in a clean packing environment. Wherein, the packing software automatically collects the current operating system lists, so that the packing software can compare the differences between before installing the software and after installing the software. After the software is installed, the comparison is executed in relation to the files, the registry files, and the service lists, so that the files that are different can be picked up packed into a single archive file.

Procedure 3: Classify the files. It is not necessary that all the files have to be loaded when the software is launched. Therefore, when the installation is complete, the files are classified into “files for firstly starting software” and “files for running the software”. Preferably, when the software is launched for the first time, not all the files will be read concurrently. Accordingly, the downloading time and the running time of the Cloud software are both saved.

Procedure 4: Draw software icons. The software icons are read in the archive file.

Procedure 5: Draw extension relation. Most software has its own extension, such as (.doc), (.docx), and (.xls). In packing the software, the extension relation is drawn and read in the archive file. Accordingly, when user selects the file via the client computers 11, the extension relation is brought in, and applied software corresponding to the extension relation can be automatically run from the Cloud Relation Area or the Cloud platform of the client computers 11.

Procedure 6: Create a single archive file. It is the last procedure to virtualize the software. All the files created during packing the software will be packed into a single archive file of a certain formation, so that the server 40 for software virtualization can import and dispatch the archive file. Herein, the archive file can be compactly dispatched to the client computers. After that, the related software does not need to download the archive file again or download it repeatedly when the software is launched to be used. Therefore, the load of the network is reduced, and an off-line application is also available.

[Server 40 for Software Virtualization]

Referring to FIG. 1, the server 40 for software virtualization includes a managing and controlling module 41, a managing and server module 42, a data transmitting server module 43, and an authorization governance module 45. The managing and controlling module 41 directs, controls, commands, and manages a cooperation of the managing and server module 42, the data transmitting server module 43, and the authorization governance module 45. The archive files of the applied software stored in the packager 30 for software virtualization are uploaded and installed in the Cloud Relation Area of the client computers 11.

When the executing module 10 of client computers is installed in the client computers 11, it logins the Cloud platform 20 through the explorer via Internet. When a flexible authorization, such as Single Sign-On, LDAP, AD, or similar authorization, is confirmed by the authorization governance module 45, the Cloud software on demand is launched. The client computers 11 run a Web-based desktop that provides software on demand. Thence, a “one click” is available to download, start, and run the Cloud software.

In order to ensure the safety of the Cloud software in the client computers 11, all the file behavior has to be executed in the Cloud Relation Area of the client computers 11. The virtual Cloud Relation Area can be dynamically mounted or removed as well as randomly moved. The virtual Cloud Relation Area is handled differently according to divergent operating systems; means to deal with the drivers and the file allocations are also different. Currently, the operating systems such as Windows 2000, Windows XP, and Windows 7 commonly have their respective Cloud Relation Area.

[Tracking and Managing the Using]

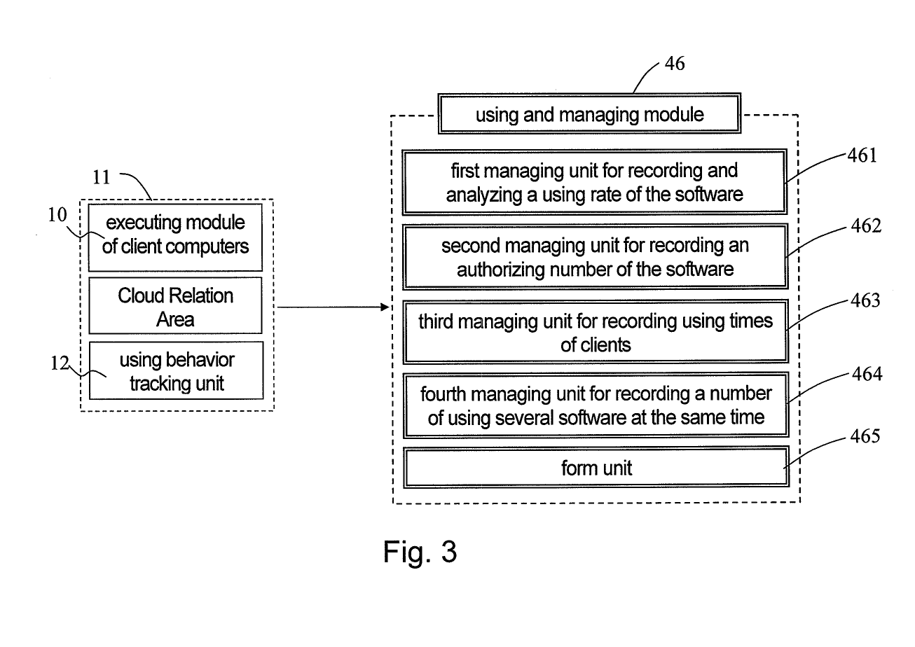

Referring to FIGS. 1 to 3, the executing module 10 of client computers includes a using behavior tracking unit 12 for recording behavior of the client computers 11 executing the Cloud software, thereby creating correspondent behavior-recorded data. The server 40 for software virtualization further includes a using and managing module 46 connected with the data transmitting server module 43 for receiving, storing, and analyzing previously discussed behavior-recorded data from the using behavior tracking unit 12.

When the client computers 11 start using the Cloud software, the using behavior tracking unit 12 begins tracking. The tracking of using behavior includes the software and the hardware.

Tracking the software: When the Cloud software is used, the using behavior tracking unit 12 transmits the behavior-recorded data to the using and managing module 46 of the server 40 for software virtualization according to the practical operation on the software. The using and managing module 46 receives the data and writes user information to the behavior-recorded data, so that if the software requires payment, the user will be charged accordingly.

Tracking the hardware: The using behavior tracking unit 12 anonymously tracks the hardware device of the client computers 11 when the Cloud software is applied. Wherein, the using behavior tracking unit 12 further sends the data of the device to the using and managing module 46 of the server 40 for software virtualization for researcher's reference.

After the download of virtualizing the software is complete, the software can be used in an off-line state. In the off-line state, a using certificate of the Cloud software from the Cloud platform 20 is brought in the system. The using certificate is for the users, and all the data that are generated during the off-line state can be recorded in the certificate. Moreover, the certificate also respectively records an expiry date of the off-line state using of the Cloud software, so that the records will be automatically sent to the server 40 for virtualization when the client computers work on-line again.

A more careful plan is executed to the using and managing module 46. The using and managing module 46 includes a first managing unit 461 for recording and analyzing a using rate of the Cloud software, a second managing unit 462 for recording an authorizing number of the Cloud software and managing a using number of the client computers at the same time, a third managing unit 463 for recording using times of a certain applied software of the client computers, a fourth managing unit 464 for recording a number of using an applied software of the client computers at the same time, and a form unit 465 that constructs forms in accordance with analyzed results from the using and managing module.

[Virtual Environment of the Cloud Server]

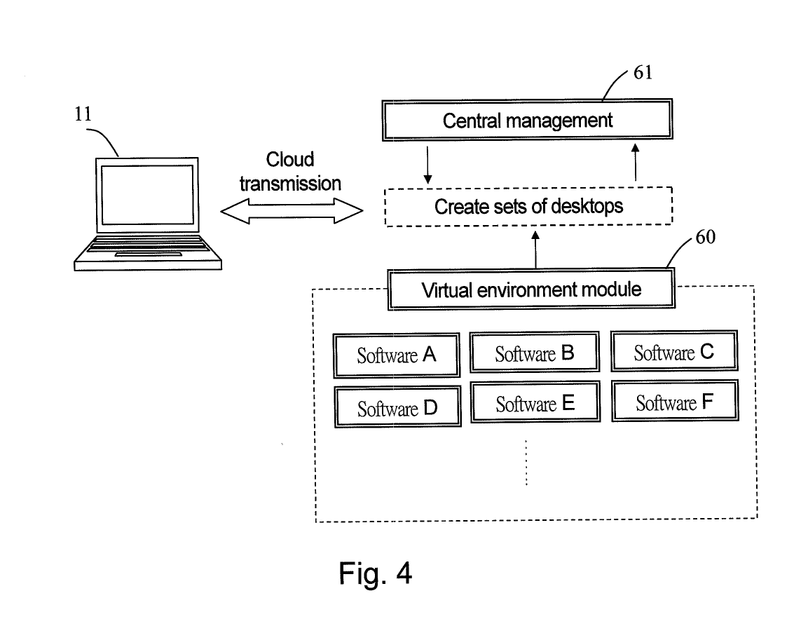

The previously discussed means for virtualizing and packing is not suited to software whose content is too large, whose registry file and COM component can not be correctly intercepted, and whose requirements include hardware keys (such as USB Key). Herein, the present invention provides a solution. FIG. 4 shows an operation environment suited to previously discussed software. A virtual environment module 60 is further installed in the Cloud platform 20. Such software is stored in the virtual environment module 60 (or software of the virtual environment) that provides an operation environment allowing the software of the virtual environment to be successfully executed. Moreover, the virtual environment module 60 creates sets of desktops. The client computers 11 are connected with the server 40 for software virtualization through the virtual environment module 60. The virtual environment module 60 further includes a central management 61 for controlling the client computers 11 connected therewith. The client computers 11 use a software using frame sent from the virtual environment module 60 through the explorer. When the client computers 11 manipulate the software of the virtual environment, signals from the mouse and the keyboard are transmitted therein. The signals from the client computers are read in the virtual environment module 60 and transformed into local signals, so that a simulation of operating behavior in the virtual environment is achieved by the software. Besides tracking the signals from the keyboard and the mouse, frames that are displayed by the software have to be captured. Thence, the captured frames are zipped and transmitted to the client computers with a terminal. Further, the behavior of the client computers 11 using the software is still recorded and analyzed by the using and managing module 46.

### CONCLUSION

To sum up, the present invention utilizes the packed and virtualized Cloud software for client computers to freely access the Cloud software via an on-line connection or via an off-line connection through a flexible application on the Cloud platform. The adopted environment includes a virtual environment of the client computers (abbreviated as Local virtualization), and a virtual environment of the Cloud server (abbreviated as Server virtualization). If the client computers provide a high power PC, the applied software on the Cloud platform is accessed via the Local virtualization. Accordingly, the resources of the hardware of the client computers are properly utilized. If a thin client is adopted, the Server virtualization is used to access the applied software on the Cloud platform. The client computers can freely choose the Local virtualization, the Server virtualization, or the both virtualization. Therefore, the flexible applications provided by the present invention preferably decrease costs for constructing Cloud servers, lower loads on the Cloud server, reduce transmitting flows of the network, centralize management and using behavior on the software, simplify publication of software, maximize a using rate of resources, promote using convenience (since an executing module of client computers is installed on the computer of the client computers, exploring websites allows the Cloud software to be freely accessed via the on-line connection or the off-line connection), trace using habits of software/hardware of client computers, and provide services of software on demand.

1. A Cloud system having flexible applications comprising:
a packager for software virtualization and a server for software virtualization being installed on a Cloud platform; said packager for software virtualization saving applied software and archive files generated after virtualization of said applied software; said server for software virtualization being connected with said packager for software virtualization so as to provide said archive files of said applied software to client computers; and
an executing module of client computers; a Cloud Relation Area being virtually installed in said client computers; said executing module of client computers letting said client computers connect with said Cloud platform; said Cloud Relation Area receiving and storing said archive files of said applied software that is downloaded; said client computers utilizing said applied software on said Cloud platform via said executing module of client computers under an on-line pattern or an off-line pattern.

2. The system as claimed in claim 1, wherein, said server for software virtualization includes a managing and controlling module, a managing and server module, and a data transmitting server module; said managing and controlling module directs, controls, commands, and manages a cooperation of said managing and server module and said data transmitting server module; said archive files of said applied software stored in said packager for software virtualization are uploaded and installed in said Cloud Relation Area of said client computers.

3. The system as claimed in claim 2, wherein, said server for software virtualization includes an authorization governance module connected with a data transmitting server module; said authorization governance module integrates with various authorization systems of different software and sets using limits of authority for said client computers.

4. The system as claimed in claim 2, wherein, said executing module of client computers includes a using behavior tracking unit for recording behavior of said client computers executing said applied software and/or installing information of hardware of said client computers, thereby creating correspondent behavior-recorded data.

5. The system as claimed in claim 4, wherein, said server for software virtualization further includes a using and managing module connected with said data transmitting server module for receiving, storing, and analyzing said behavior-recorded data.

6. The system as claimed in claim 5, wherein, said using and managing module includes a first managing unit for managing a using rate of software, thereby recording and analyzing said using rate of said applied software.

7. The system as claimed in claim 5, wherein, said using and managing module includes a second managing unit for managing an authorizing number of software, thereby recording said authorizing number of said applied software and managing a using number of said client computers at the same time.

8. The system as claimed in claim 5, wherein, said using and managing module includes a third managing unit for managing a using rate of clients, thereby recording using times of a certain applied software of said client computers.

9. The system as claimed in claim 5, wherein, said using and managing module includes a fourth managing unit for managing a parallel rate of software, thereby recording a number of using an applied software of said client computers at the same time.

10. The system as claimed in claim 5, wherein, said using and managing module includes a form unit that constructs forms in accordance with analyzed results from said using and managing module.

11. The system as claimed in claim 1, wherein, a virtual environment module is further installed in said Cloud platform; said virtual environment module is connected with said server for software virtualization; said virtual environment module stores said applied software and creates sets of desktops and software using frames for said client computers to execute said applied software; said virtual environment module further includes a central management for controlling said client computers connected with said virtual environment module.
